(19) United States
(12) Patent Application Publication
(10) Pub. No.: US 2025/0371638 A1
(43) Pub. Date: Dec. 4, 2025

(54) SYSTEMS AND METHODS FOR PREDICTING A VIOLATION PARAMETER AND OUTPUTTING FEEDBACK ABOUT A VEHICLE LAW

(71) Applicant: Toyota Motor Engineering & Manufacturing North America, Inc., Plano, TX (US)

(72) Inventors: Frederico Marcolino Quintao Severgnini, Ann Arbor, MI (US); Raymond Peter Viviano, Hazel Park, MI (US)

(21) Appl. No.: 18/678,660

(22) Filed: May 30, 2024

(51) Int. Cl. G06Q 50/26; G01C 21/36

(52) U.S. Cl. CPC G06Q 50/265; G01C 21/3697

(57) ABSTRACT

Systems, methods, and other embodiments described herein relate to generating a behavior profile and predicting a violation parameter for preventing an operator from breaking a vehicle law beyond a travel area. In one embodiment, a method includes generating a behavior profile of an operator from historical data and estimating a vehicle law, the historical data is acquired from a travel area associated with the operator and the behavior profile includes driving habits about the operator. The method also includes predicting a violation parameter of the vehicle law from the behavior profile and a vehicle maneuver at a location, and the location is outside of the travel area. The method also includes upon satisfying the violation parameter, outputting feedback by a vehicle about the vehicle law.

### TECHNICAL FIELD

The subject matter described herein relates, in general, to predicting violations of a vehicle law, and, more particularly, to generating a behavior profile for predicting a violation parameter from a travel area and outputting feedback.

### BACKGROUND

Vehicles acquire sensor data to assist an operator with driving tasks. For example, vehicles perceive other vehicles, obstacles, pedestrians, and additional aspects of a surrounding environment using the sensor data. Furthermore, vehicles can process positioning data for assisting the operator with navigation and generating vehicle commands by an automated driving system (ADS) during automated driving. As such, the sensor data improves driving tasks that rely upon perceiving the surrounding environment and computing accurate position about a vehicle.

In various implementations, systems that execute tasks using the sensor data encounter limitations when assisting an operator during certain travel scenarios. For example, an operator controls a vehicle in a known area according to vehicle laws using positioning information derived from the sensor data. However, the operator may violate vehicle laws when outside of the known area since vehicle laws vary by geography. Subconsciously, the operator may also maneuver the vehicle following certain vehicle laws while violating others that are loosely enforced in the known area without the sensor data having additional insight. Since enforcement also varies by geography, the operator could face penalties while driving in an unknown area. Therefore, systems relying on sensor data to navigate outside of a known area encounter limitations that can reduce driver support capabilities.

### SUMMARY

In one embodiment, example systems and methods that relate to generating a behavior profile and predicting a violation parameter for preventing an operator from breaking a vehicle law beyond a travel area are disclosed. In various implementations, systems inform an operator about a vehicle law within a locality sometimes indicate limited insight about traffic maneuvers that violate the vehicle law. For example, a system informs an operator about a speed limit and location of speed areas in a bordering state outside a familiar travel area. However, the system does not warn the operator that a u-turn is illegal at certain intersection types lacking signage within the bordering state. As such, the operator violates the law in the bordering state and creates an unsafe traffic scenario since the operator regularly performs u-turns in the travel area that are legal. Accordingly, an operator relying upon a system for guidance within an unfamiliar travel area can encounter traffic violations and unsafe conditions.

Therefore, in one embodiment, a prediction system estimates whether an operator will control a vehicle correctly beyond a travel area and builds awareness about a vehicle law using a behavior profile that is generated. Here, the travel area may be a state, locality, etc., where the operator frequently drives the vehicle and the behavior profile includes driving habits, such as driving violations by the operator within the travel area. The prediction system estimates violations beyond the travel area by predicting a violation parameter of the vehicle law from the behavior profile and vehicle maneuvering at a location. For example, the violation parameter factors that the vehicle law applies outside of the travel area while being absent within the travel area and the operator is unfamiliar with the vehicle law. The prediction system can also derive from the behavior profile that the operator is likely to violate the vehicle law and the vehicle maneuvering indicating confusion (e.g., irregular acceleration) will lead to a violation since enforcement is common within the region (e.g., elevated police surveillance). Upon satisfying the operator parameter, the prediction system can increase awareness about the vehicle law through feedback (e.g., a voice assistant), particularly when an illegal maneuver is imminent. Therefore, the prediction system improves driving by warning an operator about a vehicle law through anticipating violations from a behavior profile and vehicle maneuvering, thereby increasing safety and cost savings.

In one embodiment, a prediction system for generating a behavior profile and predicting a violation parameter for preventing an operator from breaking a vehicle law beyond a travel area is disclosed. The prediction system includes a memory including instructions that, when executed by a processor, cause the processor to generate a behavior profile of an operator from historical data and estimate a vehicle law, the historical data is acquired about a travel area associated with the operator and the behavior profile includes driving habits of the operator. The instructions also include instructions to predict a violation parameter of the vehicle law from the behavior profile and a vehicle maneuver at a location, and the location is outside of the travel area. The instructions also include instructions to output feedback by a vehicle about the vehicle law upon satisfying the violation parameter.

In one embodiment, a non-transitory computer-readable medium for generating a behavior profile and predicting a violation parameter for preventing an operator from breaking a vehicle law beyond a travel area and including instructions that when executed by a processor cause the processor to perform one or more functions is disclosed. The instructions include instructions to generate a behavior profile of an operator from historical data and estimate a vehicle law, the historical data is acquired about a travel area associated with the operator and the behavior profile includes driving habits of the operator. The instructions also include instructions to predict a violation parameter of the vehicle law from the behavior profile and a vehicle maneuver at a location, and the location is outside of the travel area. The instructions also include instructions to output feedback by a vehicle about the vehicle law upon satisfying the violation parameter.

In one embodiment, a method for generating a behavior profile and predicting a violation parameter for preventing an operator from breaking a vehicle law beyond a travel area is disclosed. In one embodiment, the method includes generating a behavior profile of an operator from historical data and estimating a vehicle law, the historical data is acquired from a travel area associated with the operator and the behavior profile includes driving habits about the operator. The method also includes predicting a violation parameter of the vehicle law from the behavior profile and a vehicle maneuver at a location, and the location is outside of the travel area. The method also includes upon satisfying the violation parameter, outputting feedback by a vehicle about the vehicle law.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a prediction system that is associated with estimating that an operator will control a vehicle correctly beyond a travel area using a behavior profile.

FIG. 3 illustrates one example of the prediction system generating a behavior profile using sensor data for estimating operator habits and maneuver handling.

FIG. 4 illustrates one example of the prediction system operating beyond the travel area and preemptively warning an operator about a vehicle law.

FIG. 5 illustrates one embodiment of a method that is associated with predicting a violation parameter of a vehicle law from a behavior profile and a vehicle maneuver at a location.

### DETAILED DESCRIPTION

Systems, methods, and other embodiments associated with generating a behavior profile for preventing an operator from violating a vehicle law beyond a travel area are disclosed herein. In various implementations, systems that assist operators with awareness about a vehicle law encounter difficulties such as false positives that hamper confidence. For example, a system that overactively warns an operator about a vehicle law that varies from state-to-state, province-to-province becomes ineffective from an operator ignoring alerts. As such, the operator on a road trip outside a travel area can lack awareness about the nuances associated with traffic rules while traveling across state lines.

Therefore, in one embodiment, a prediction system informs an operator about local laws when awareness is lacking using a behavior profile that is generated and estimating a vehicle law among a location. In one approach, the prediction system generates a behavior profile within a travel area associated with the operator (e.g., a home locale) and the behavior profile reflects driving habits derived from historical drives. The prediction system can process drive logs for building the behavior profile and predicting that the operator will respond incorrectly to a vehicle law beyond the travel area upon crossing into a new territory. For instance, the prediction system gently informs the operator about the vehicle law when the operator turns right on red in a state disallowing a maneuver. The prediction system may output this information, particularly upon the operator repeatedly making the maneuver as a mistake, such as through automatically displaying a “no turn on red sign” on the vehicle dashboard. Furthermore, in one approach, a voice assistant notifies the operator about the vehicle law that can include nuances, such as recent enforcement data derived from crowdsourced information.

Additionally, in one embodiment, the prediction system estimates the vehicle law through identifying traffic indicators (e.g., road signs, traffic lights, etc.) from image data acquired about the area around the vehicle and outputs feedback accordingly. In this way, the prediction system can anticipate a violation when an acquired vehicle law is outdated, such when traveling through a construction zone. Furthermore, the prediction system can estimate a violation parameter associated with the vehicle law for selecting when to output the feedback about the vehicle law. For example, the prediction system estimates enforcement of the vehicle law by factoring local nuances such as safety zones and infrastructure (e.g., radar, a speed camera, etc.) associated with the location. In one approach, the violation parameter factors a confidence level for handling a vehicle maneuver and travel within the location using data such as a steering angle, pulse rate, and respiratory rate. Accordingly, the prediction system preemptively prevents illegal maneuvers through informing the operator about a vehicle law outside a travel area using a behavior profile and maneuver handling for a location, thereby improving driving experiences and enhancing navigation guidance.

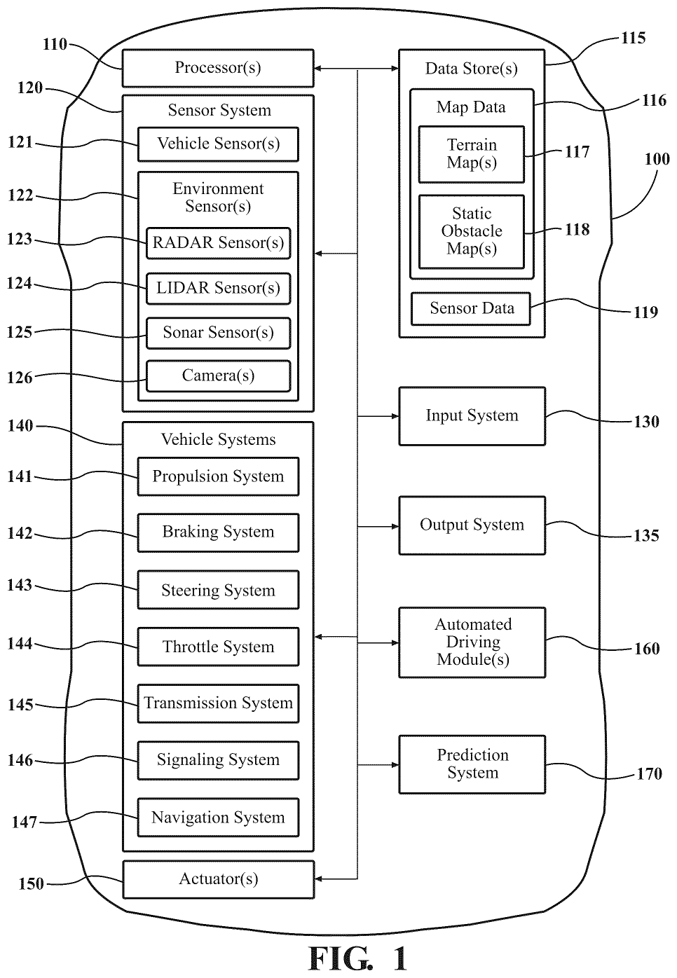

Referring to FIG. 1, an example of a vehicle 100 is illustrated. As used herein, a “vehicle” is any form of motorized transport. In one or more implementations, the vehicle 100 is an automobile. While arrangements will be described herein with respect to automobiles, it will be understood that embodiments are not limited to automobiles. In some implementations, a prediction system 170 uses road-side units (RSU), consumer electronics (CE), mobile devices, robots, drones, and so on that benefit from the functionality discussed herein associated with generating a behavior profile and predicting a violation parameter for preventing an operator from breaking laws beyond a travel area.

The vehicle 100 also includes various elements. It will be understood that in various embodiments, the vehicle 100 may have less than the elements shown in FIG. 1. The vehicle 100 can have any combination of the various elements shown in FIG. 1. Furthermore, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Furthermore, the elements shown may be physically separated by large distances. For example, as discussed, one or more components of the disclosed system can be implemented within a vehicle while further components of the system are implemented within a cloud-computing environment or other system that is remote from the vehicle 100.

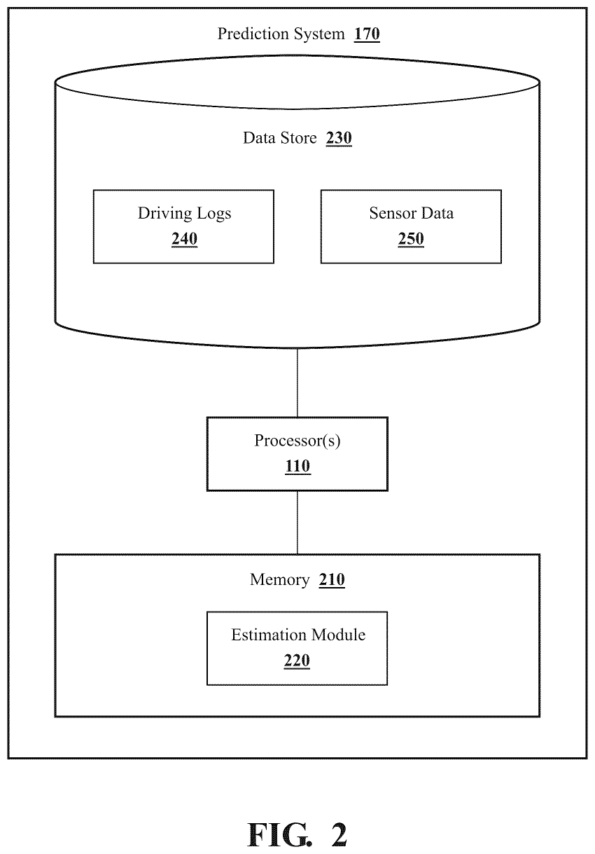

Some of the possible elements of the vehicle 100 are shown in FIG. 1 and will be described along with subsequent figures. However, a description of many of the elements in FIG. 1 will be provided after the discussion of FIGS. 2-5 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, the vehicle 100 includes a prediction system 170 that is implemented to perform methods and other functions as disclosed herein relating to generating a behavior profile and predicting a violation parameter for preventing an operator from breaking laws beyond a travel area. In one approach, functionality associated with at least one module of the prediction system 170 is implemented within the vehicle 100 while further functionality is implemented within a server (e.g., a cloud-based server).

With reference to FIG. 2, one embodiment of the prediction system 170 of FIG. 1 is further illustrated. The prediction system 170 is shown as including a processor(s) 110 from the vehicle 100 of FIG. 1. Accordingly, the processor(s) 110 may be a part of the prediction system 170, the prediction system 170 may include a separate processor from the processor(s) 110 of the vehicle 100, or the prediction system 170 may access the processor(s) 110 through a data bus or another communication path. In one embodiment, the prediction system 170 includes a memory 210 that stores an estimation module 220. The memory 210 is a random-access memory (RAM), a read-only memory (ROM), a hard-disk drive, a flash memory, or other suitable memory for storing the estimation module 220. The estimation module 220 is, for example, computer-readable instructions that when executed by the processor(s) 110 cause the processor(s) 110 to perform the various functions disclosed herein.

Moreover, the estimation module 220 generally includes instructions that function to control the processor(s) 110 to receive data inputs from one or more sensors of the vehicle 100. The inputs are, in one embodiment, observations of one or more objects in an environment proximate to the vehicle 100 and/or other aspects about the surroundings. As provided for herein, the prediction system 170, in one embodiment, acquires sensor data 250 that includes at least camera images. In further arrangements, the prediction system 170 acquires the sensor data 250 from further sensors such as radar sensors 123, LIDAR sensors 124, and other sensors as may be suitable for identifying vehicles and locations of the vehicles.

Accordingly, the prediction system 170, in one embodiment, controls the respective sensors to provide the data inputs in the form of the sensor data 250. Additionally, while the prediction system 170 is discussed as controlling the various sensors to provide the sensor data 250, in one or more embodiments, the prediction system 170 can employ other techniques to acquire the sensor data 250 that are either active or passive. For example, the prediction system 170 may passively sniff the sensor data 250 from a stream of electronic information provided by the various sensors to further components within the vehicle 100. Moreover, the prediction system 170 can undertake various approaches to fuse data from multiple sensors when providing the sensor data 250 and/or from sensor data acquired over a wireless communication link. Thus, the sensor data 250, in one embodiment, represents a combination of perceptions acquired from multiple sensors.

In addition to locations of surrounding vehicles, the sensor data 250 may also include, for example, information about lane markings, and so on. Moreover, the prediction system 170, in one embodiment, controls the sensors to acquire the sensor data 250 about an area that encompasses 360 degrees about the vehicle 100 in order to provide a comprehensive assessment of the surrounding environment. Of course, in alternative embodiments, prediction system 170 may acquire the sensor data about a forward direction alone when, for example, the vehicle 100 is not equipped with further sensors to include additional regions about the vehicle and/or the additional regions are not scanned due to other reasons.

In various implementations, the prediction system 170 includes a data store 230. In one embodiment, the data store 230 is a database. The database is, in one embodiment, an electronic data structure stored in the memory 210 or another data store and that is configured with routines that can be executed by the processor(s) 110 for analyzing stored data, providing stored data, organizing stored data, and so on. Thus, in one embodiment, the data store 230 stores data used by the prediction system 170 and the estimation module 220 in executing various functions. In one embodiment, the data store 230 includes the sensor data 250 along with, for example, metadata that characterize various aspects of the sensor data 250. For example, the metadata can include location coordinates (e.g., longitude and latitude), relative map coordinates or tile identifiers, time/date stamps from when the separate sensor data 250 was generated, and so on. In one embodiment, the data store 230 further includes driving logs 240 for generating a behavior profile. For example, the driving logs 240 indicate that an operator regularly turns right on red, makes u-turns, etc., when the operator drives within a familiar travel area. The driving log can also indicate that the operator commonly speeds on a highway while observing speed limits within urban areas. In this way, the prediction system 170 generates the behavior profile from historical data reflected by the driving logs 240 that reliably indicate maneuver propensities and habits.

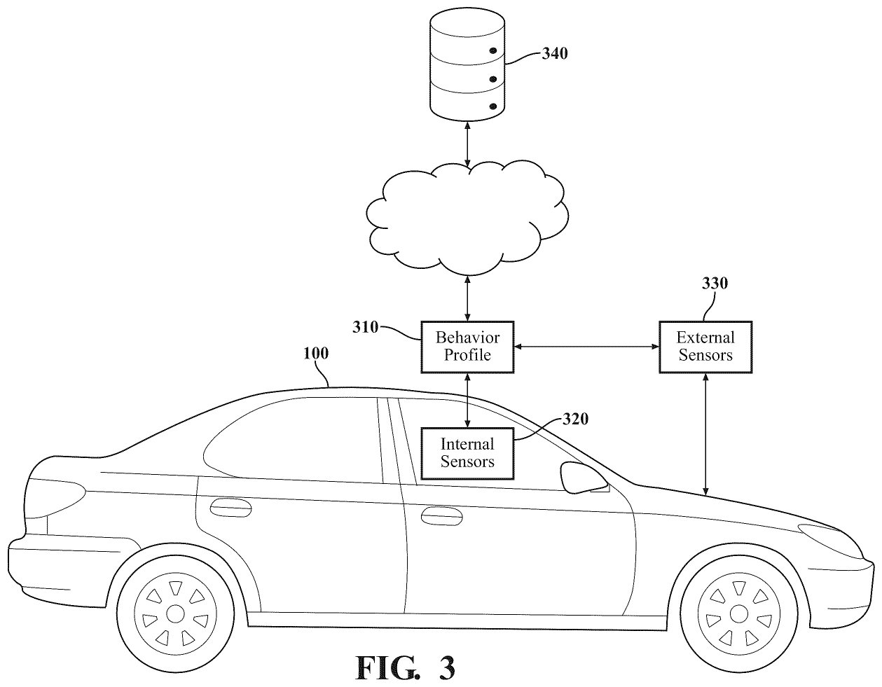

Now turning to FIG. 3, one example of the prediction system 170 generating a behavior profile 310 using the driving logs and/or the sensor data 250 for estimating operator habits and maneuver handling is illustrated. The prediction system 170, in one embodiment, is further configured to perform additional tasks beyond controlling the respective sensors to acquire and provide the sensor data 250. For example, the prediction system includes instructions that cause the processor 110 to generate the behavior profile 310 of an operator from historical data and estimate a vehicle law, the historical data is acquired from a travel area associated with the operator and the behavior profile 310 includes driving habits about the operator. The estimation module 220 may predict a violation parameter of the vehicle law from the behavior profile 310 and a vehicle maneuver at a location that is outside of the travel area. Furthermore, the prediction system 170 outputs feedback by a vehicle about the vehicle law upon satisfying the violation parameter.

Regarding details about generating the behavior profile 310, the prediction system 170 builds awareness about the travel area (e.g., a home locality, a familiar area, etc.) associated with an operator through direct input received from input system 130, the driving logs 240, etc. For example, the prediction system 170 generates the behavior profile 310 using data from past driving habits, logging particular maneuvers (e.g., turning right on red, making u-turns, etc.), etc. The direct input can include data from internal sensors 320 (e.g., a cabin camera, a seat sensor, etc.) that the prediction system 170 processes to derive nuances about driving habits.

In FIG. 3, the vehicle 100 also includes external sensors 330. Here, the internal sensors 320 and external sensors 330 may be separate or part of environment sensors 122. In one approach, the prediction system 170 infers using gaze data from the internal sensors 320 and the sensor data 250 that the operator drives above a speed limit on a highway when distracted. As explained below, the prediction system 170 can utilize this relationship for intelligently and reliably outputting feedback about a vehicle law outside the travel area. Furthermore, the behavior profile 310 can also reflect driving violations by the operator within the travel area, such as violations lacking traffic tickets from law enforcement within the travel area that become habitual. In another scenario, the behavior profile can ignore driving violations that are unticketed and habitual by the operator within the travel area. In this way, the behavior profile 310 reflects intelligent insights about the driving propensities of the operator within the context of a vehicle law and the travel area.

In one approach, the prediction system 170 estimates the vehicle law through identifying traffic indicators (e.g., road signs, traffic symbols, traffic lights, etc.) using image data acquired from the external sensors 330 (e.g., cameras, radar, LiDAR, etc.). The image data can represent a scene surrounding the vehicle 100 and stored within the sensor data 250. Here, the prediction system 170 can fill gaps about vehicle laws outside the travel area for a current location, such as location determined from global position system (GPS) information. The gaps may also exist for vehicle laws acquired from a server 340 (e.g., a cloud server, a cloud database, etc.) over a network. For instance, the vehicle laws lack rule information about short-term changes associated with a construction zone reducing speed limits. As another example, the vehicle laws information about a recent installation of traffic cameras outside the travel area. As such, the prediction system 170 can include a computer vision engine that “reads” signs on the road through extracting and classifying objects from the image data.

In various implementations, the prediction system 170 uses a machine learning (ML) algorithm, such as a convolutional neural network (CNN), to perform semantic segmentation over the image data, the sensor data 250 from which further information is derived about a vehicle law and the surrounding environment. Of course, in further aspects, the prediction system 170 may employ different machine learning algorithms or implement different approaches for performing the associated functions, which can include deep convolutional encoder-decoder architectures, or another suitable approach that generates semantic labels for the separate object classes represented in the image data. Whichever particular approach the prediction system 170 implements, the ML algorithm outputs semantic labels identifying objects represented in the image data, the sensor data 250, etc. In this way, the prediction system 170 can compare the output including traffic signs with the vehicle laws to fill gaps, augment existing data, etc., thereby improving safety.

Additionally, the prediction system 170 can upload, acquire, etc., the behavior profile from the server 340 for portability. For example, the operator approves (e.g., under a privacy policy) that the behavior profile 310 can be ported to other vehicles. The vehicle 100 acquires the behavior profile 310 when renting a vehicle while traveling internationally, buying a new vehicle, etc. Thus, the prediction system 170 improves convenience through making the behavior profile portable to vehicles other than the vehicle 100.

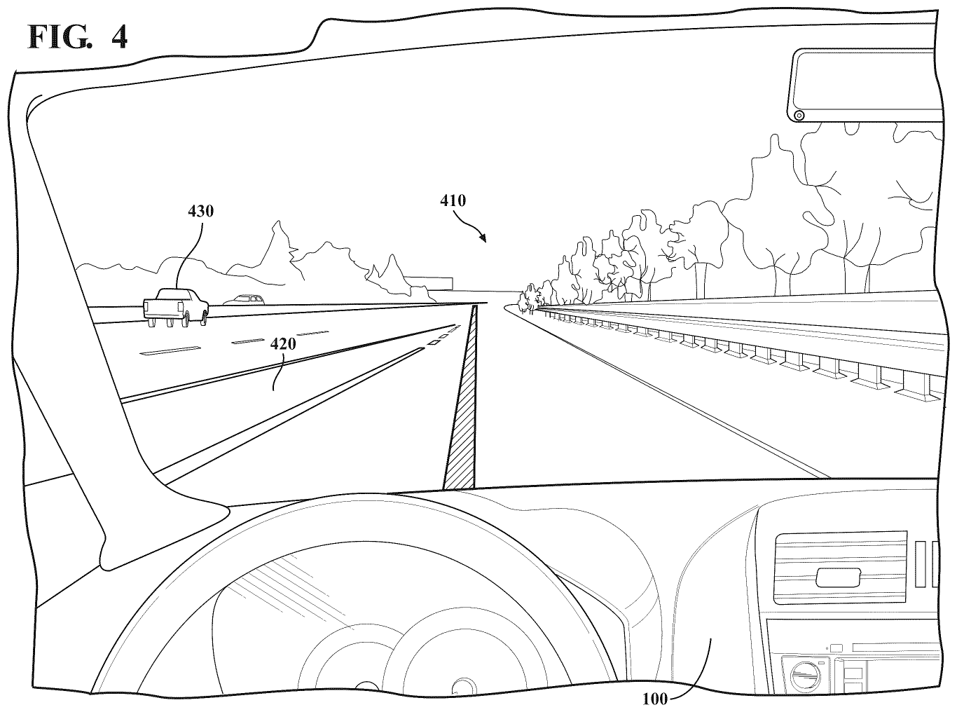

Regarding FIG. 4, one example of the prediction system 170 operating beyond the travel area and preemptively warning an operator about a vehicle law is illustrated. Here, the vehicle 100 encounters a driving scenario 410 of merging onto a road having a median 420 and a pickup-truck 430. The prediction system 170 can process GPS information, detect current location, etc., and estimate that the operator is traveling in an unfamiliar location. The prediction system 170 anticipates which vehicle law an operator may accidentally break through maneuvers when the vehicle 100 enters a new locality, a location with a vehicle law different than the travel area regularly driven, etc. Here, the estimation module 220 can predict a violation parameter of the vehicle law from a behavior profile generated with the driving logs 240 and a vehicle maneuver at the location. In one approach, the estimation module 220 computes a confidence level of the operator for the vehicle maneuver and travel within the location using the sensor data 250 as representing context among the driving scenario 410. For instance, the sensor data 250 includes one of a steering angle and a braking frequency associated with the operator. The steering angle can indicate stress and anxiety when the operator is drifting, executing sharp maneuvers, appearing lost from missing navigation prompts, etc. The confidence level can also factor traffic data associated with a location. For example, the prediction system 170 computes a collision probability with the location when the vehicle 100 is drifting on a road curve known as dangerous indicated by the traffic data. In another example, a server acquires the traffic data from a vehicle fleet and transmits the traffic data to the vehicle 100.

An operator, in one embodiment, lacks confidence when making mistakes and panicking while having an elevated pulse rate, respiratory rate, electrodermal activity, etc., as extrapolated from information outputted by a biosensor. The prediction system 170 can derive context from the information such as differentiating between anxiety linked to driving within an unfamiliar location and driving with a medical condition (e.g., a virus). For example, the pulse and respiratory rates remain elevated with a medical condition. Driving within an unfamiliar location with anxiety may exhibit an elevated pulse rate and constant respiratory rate. In this way, the prediction system 170 avoids false positives when outputting feedback about traffic laws when the operator drives beyond the travel area (e.g., a familiar region, a home country, etc.).

In various implementations, the prediction system 170 and/or estimation module 220 measures the appropriateness of driving maneuvers (e.g., turning on a red light, u-turns, moving lanes, driving the wrong way (e.g., one-way street, highway, etc.)), etc., in real-time. For example, the prediction system 170 detects scene information (e.g., road signs, lane lines, road boundaries, etc.) using the computer vision engine and monitors vehicle parameters (e.g., speed, acceleration, steering wheel location, etc.). The prediction system 170 can compare the driving maneuver to the behavior profile for predicting whether the operator will accidentally violate the vehicle law. In one approach, the prediction system 170 estimates that the operator missed, misunderstood, etc. a traffic indicator (e.g., a road sign) since the road does not exist within the travel area, the road has a non-standard symbol, etc. If the maneuver is illegal and a violation likely, the prediction system 170 outputs feedback to the operator. For instance, a voice system outputs a reminder and/or explanation about the vehicle law “e.g., turning on red in Nebraska with a red arrow displayed is illegal.” In another example, the prediction system displays a notice on the vehicle dash, heads-up display (HUD), etc., using output system 135.

Upon computing the violation parameter, the prediction system 170 determines whether the violation parameter is satisfied. For example, the prediction system 170 detects that the vehicle maneuver violates the vehicle law using a threshold. Here, the threshold can be driving a certain quantity above a speed limit, hours driven that impact fatigue, etc. Another example is the prediction system 170 recognizing that the vehicle law applies outside of the travel area and the vehicle law is absent within the travel area.

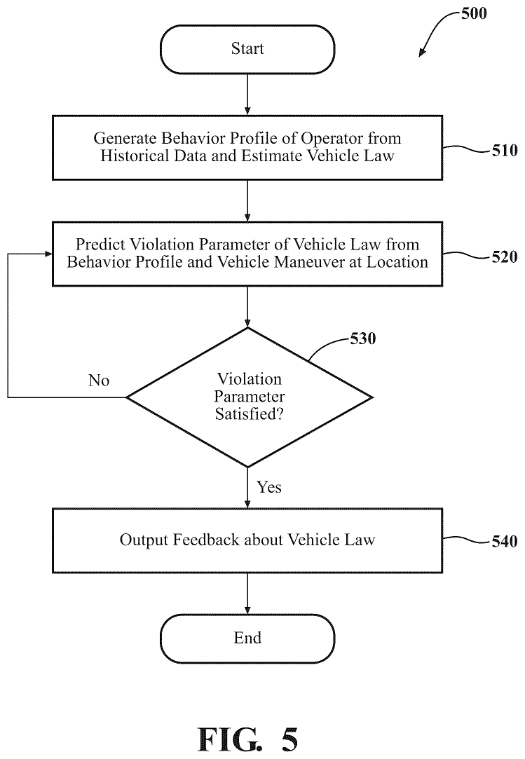

Now referring to FIG. 5, a flowchart of a method 500 that is associated with predicting a violation parameter of a vehicle law from a behavior profile and a vehicle maneuver at a location is illustrated. Method 500 will be discussed from the perspective of the prediction system 170 of FIGS. 1 and 2. While method 500 is discussed in combination with the prediction system 170, it should be appreciated that the method 500 is not limited to being implemented within the prediction system 170 but is instead one example of a system that may implement the method 500. The method 500 can automatically determine if an operator will respond correctly in unfamiliar situation using local vehicle laws and building the behavior profile individualized within home locale. As previously explained above, the prediction system 170 can generate the behavior profile using machine vision, in-cabin monitoring, etc. For example, the behavior profile indicates that the operator turns on red, makes illegal u-turns, etc.

At 510, the prediction system 170 generates a behavior profile of an operator from historical data and estimates a vehicle law. Here, the prediction system 170 can acquire the historical data about a travel area associated with the operator (e.g., a home locale) using the environment sensors 122. This can include a direct input received from the input system 130, the driving logs 240, etc., and indirect perceptions. For instance, the prediction system 170 acquires gaze data from the environment sensors 122 and the sensor data 250 and estimates that the operator drives above a speed limit on a highway when fatigued. In one approach, the prediction system 170 generates the behavior profile using data from previously estimated driving habits, logging particular maneuvers (e.g., turning right on red, making u-turns, etc.), etc.

Moreover, the behavior profile may incorporate driving violations by the operator within the travel area, such as habitual violations lacking traffic tickets from law enforcement within the travel area in an urban neighborhood. In another scenario, the behavior profile ignores driving violations by the operator and the prediction system 170 generates feedback in normal course. Thus, the behavior profile can represent driving habits about the operator and robust insights within the context of a vehicle law.

As previously explained, the prediction system 170 can estimate the vehicle law through using image data acquired from the environment sensors about a scene surrounding the vehicle 100. The estimates can fill gaps about vehicle laws outside the travel area. For example, the vehicle laws lack rule changes about a construction zone reducing speed limits. The prediction system 170 can include a computer vision engine that detects traffic indicators (e.g., road signs, road symbols, traffic lights, etc.) through extracting and classifying objects from the image data, such as using a ML algorithm (e.g., a CNN). In this way, the prediction system 170 can comprehensively assess maneuvers by the vehicle 100 and assist the compliance with a vehicle law outside the travel area.

At 520, the estimation module 220 predicts a violation parameter of the vehicle law from the behavior profile and a vehicle maneuver at a location. As previously explained, the prediction system 170 uses the violation parameter for factoring nuances such as enforcement likelihood, operator habits, safety parameters, etc. In this way, the prediction system 170 avoids false negatives and positives when outputting feedback and guiding the operator. Here, the prediction system 170 can also detect a current location and determines that the operator is traveling in an unfamiliar location. The violation parameter can anticipate which vehicle law an operator may accidentally break through maneuvers when the vehicle 100 enters a new locality and location with a vehicle law different than the travel area regularly driven.

In one approach, the estimation module 220 calculates a confidence level of the operator for the vehicle maneuver and travel within the location using contextual information and augments the violation parameter. For instance, a steering angle indicates stress and anxiety when the operator is drifting, executing sharp maneuvers, lost at the location, etc. As another example, the prediction system 170 computes a collision probability with the location when the vehicle maneuver includes drifting on a road curve known as dangerous. In this way, the violation parameter affords a comprehensive assessment about the operator breaking a law and determining assistive actions by the vehicle 100.

At 530, the prediction system 170 computes whether the violation parameter is satisfied. Here, meeting a threshold may satisfy the violation parameter. For example, the threshold can be driving a certain amount above a speed limit. Another example is that the vehicle law is more common on roads outside of the travel area. If the violation parameter is unmet, the estimation module 220 continues predictions and computations for the violation parameter of the vehicle law from the behavior profile at 520 until the violation parameter is met.

At 540, upon satisfying the violation parameter, the prediction system 170 outputs feedback about the vehicle law. For instance, the prediction system displays a notice on the vehicle dash, heads-up display (HUD), etc., using the output system 135 about a violation, anticipated violation, etc. Furthermore, a voice system can output a reminder and/or explanation about the vehicle law, thereby building awareness about the vehicle law outside the travel area. Thus, the prediction system assists the operator with building awareness about vehicle laws and preemptively prevents illegal maneuvers outside the travel area using the behavior profile and detected vehicle maneuvers for a location that improves safety and reduces citation costs.

FIG. 1 will now be discussed in full detail as an example environment within which the system and methods disclosed herein may operate. In some instances, the vehicle 100 is configured to switch selectively between different modes of operation/control according to the direction of one or more modules/systems of the vehicle 100. In one approach, the modes include: 0, no automation; 1, driver assistance; 2, partial automation; 3, conditional automation; 4, high automation; and 5, full automation. In one or more arrangements, the vehicle 100 can be configured to operate in a subset of possible modes.

In one or more embodiments, the vehicle 100 is an automated or autonomous vehicle. As used herein, “autonomous vehicle” refers to a vehicle that is capable of operating in an autonomous mode (e.g., category 5, full automation). “Automated mode” or “autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU), an application-specific integrated circuit (ASIC), a microprocessor, etc. The vehicle 100 can include one or more data stores 115 for storing one or more types of data. The data store(s) 115 can include volatile and/or non-volatile memory. Examples of suitable data stores 115 include RAM, flash memory, ROM, programmable read-only memory (PROM), erasable programmable read-only memory (EPROM), electrically erasable programmable read-only memory (EEPROM), registers, magnetic disks, optical disks, and hard drives. The data store(s) 115 can be a component of the processor(s) 110, or the data store(s) 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry.

In one or more arrangements, the map data 116 can include one or more terrain maps 117. The terrain map(s) 117 can include information about the terrain, roads, surfaces, and/or other features of one or more geographic areas. The terrain map(s) 117 can include elevation data in the one or more geographic areas. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles can include trees, buildings, curbs, fences, railings, medians, utility poles, statues, monuments, signs, benches, furniture, mailboxes, large rocks, or hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

One or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information about one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means a device that can detect, and/or sense something. In at least one embodiment, the one or more sensors detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors may function independently or two or more of the sensors may function in combination. The sensor system 120 and/or the one or more sensors can be operatively connected to the processor(s) 110, the data store(s) 115, and/or another element of the vehicle 100. The sensor system 120 can produce observations about a portion of the environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect information about the vehicle 100 itself. In one or more arrangements, the vehicle sensor(s) 121 can be configured to detect position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect one or more characteristics of the vehicle 100 and/or a manner in which the vehicle 100 is operating. In one or more arrangements, the vehicle sensor(s) 121 can include a speedometer to determine a current speed of the vehicle 100.

Alternatively, or in addition, the sensor system 120 can include the one or more environment sensors 122 configured to acquire data about an environment surrounding the vehicle 100 in which the vehicle 100 is operating. “Surrounding environment data” includes data about the external environment in which the vehicle is located or one or more portions thereof. For example, the one or more environment sensors 122 can be configured to sense obstacles in at least a portion of the external environment of the vehicle 100 and/or data about such obstacles. Such obstacles may be stationary objects and/or dynamic objects. The one or more environment sensors 122 can be configured to detect other things in the external environment of the vehicle 100, such as, for example, lane markers, signs, traffic lights, traffic signs, lane lines, crosswalks, curbs proximate to the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more of: radar sensors 123, LIDAR sensors 124, sonar sensors 125, weather sensors, haptic sensors, locational sensors, and/or one or more cameras 126. In one or more arrangements, the one or more cameras 126 can be high dynamic range (HDR) cameras, stereo, or infrared (IR) cameras.

The vehicle 100 can include the input system 130. An “input system” includes components or arrangement or groups thereof that enable various entities to enter data into a machine. The input system 130 can receive an input from a vehicle occupant. The vehicle 100 can include the output system 135. An “output system” includes one or more components that facilitate presenting data to a vehicle occupant.

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, any of the systems or portions thereof may be otherwise combined or segregated via hardware and/or software within the vehicle 100. The vehicle 100 can include a propulsion system 141, a braking system 142, a steering system 143, a throttle system 144, a transmission system 145, a signaling system 146, and/or a navigation system 147. Any of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the prediction system 170, and/or the automated driving module(s) 160 can be operatively connected to communicate with the various vehicle systems 140 and/or individual components thereof. For example, the processor(s) 110 and/or the automated driving module(s) 160 can be in communication to send and/or receive information from the various vehicle systems 140 to control the movement of the vehicle 100. The processor(s) 110, the prediction system 170, and/or the automated driving module(s) 160 may control some or all of the vehicle systems 140 and, thus, may be partially or fully autonomous as defined by the society of automotive engineers (SAE) levels 0 to 5.

The processor(s) 110, the prediction system 170, and/or the automated driving module(s) 160 can be operatively connected to communicate with the various vehicle systems 140 and/or individual components thereof. For example, the processor(s) 110, the prediction system 170, and/or the automated driving module(s) 160 can be in communication to send and/or receive information from the various vehicle systems 140 to control the movement of the vehicle 100. The processor(s) 110, the prediction system 170, and/or the automated driving module(s) 160 may control some or all of the vehicle systems 140.

The processor(s) 110, the prediction system 170, and/or the automated driving module(s) 160 may be operable to control the navigation and maneuvering of the vehicle 100 by controlling one or more of the vehicle systems 140 and/or components thereof. For instance, when operating in an autonomous mode, the processor(s) 110, the prediction system 170, and/or the automated driving module(s) 160 can control the direction and/or speed of the vehicle 100. The processor(s) 110, the prediction system 170, and/or the automated driving module(s) 160 can cause the vehicle 100 to accelerate, decelerate, and/or change direction. As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be an element or a combination of elements operable to alter one or more of the vehicle systems 140 or components thereof responsive to receiving signals or other inputs from the processor(s) 110 and/or the automated driving module(s) 160. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processors 110. Alternatively, or in addition, one or more data stores 115 may contain such instructions.

In one or more arrangements, one or more of the modules described herein can include artificial intelligence elements, e.g., neural network, fuzzy logic, or other machine learning algorithms. Furthermore, in one or more arrangements, one or more of the modules can be distributed among a plurality of the modules described herein. In one or more arrangements, two or more of the modules described herein can be combined into a single module.

The vehicle 100 can include one or more automated driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine position and velocity of the vehicle 100. The automated driving module(s) 160 can determine the location of obstacles, obstacles, or other environmental features including traffic signs, trees, shrubs, neighboring vehicles, pedestrians, etc.

The automated driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module(s) 160 either independently or in combination with the prediction system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data 250. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module(s) 160 can be configured to implement determined driving maneuvers. The automated driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-5, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk™, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A prediction system comprising:
a memory storing instructions that, when executed by a processor, cause the processor to:
generate a behavior profile of an operator from historical data and estimate a vehicle law, the historical data is acquired about a travel area associated with the operator and the behavior profile includes driving habits of the operator;
predict a violation parameter of the vehicle law from the behavior profile and a vehicle maneuver at a location, and the location is outside of the travel area; and
upon satisfaction of the violation parameter, output feedback by a vehicle about the vehicle law.

2. The prediction system of claim 1, wherein the instructions to satisfy the violation parameter further include instructions to detect that the vehicle maneuver violates the vehicle law, and the vehicle law applies outside of the travel area and the vehicle law is absent within the travel area.

3. The prediction system of claim 2, wherein the instructions to predict the violation parameter further include instructions to infer enforcement of the vehicle law by factoring one of a safety zone, radar enforcement, and a speed camera associated with the location.

4. The prediction system of claim 1, wherein the instructions to predict the violation parameter further include instructions to infer a confidence level of the operator for the vehicle maneuver and travel within the location using data from a sensor, and the data includes one of a steering angle, a braking frequency, a pulse rate, a respiratory rate, electrodermal activity, pupil dilation, and body temperature associated with the operator.

5. The prediction system of claim 4, wherein the instructions to predict the violation parameter further include instructions to compute a probability of a collision associated with the location.

6. The prediction system of claim 1, wherein the instructions to estimate the vehicle law further include instructions to identify traffic symbols using image data about a scene surrounding the vehicle.

7. The prediction system of claim 1, wherein the behavior profile is portable to a transportation apparatus other than the vehicle.

8. The prediction system of claim 1, wherein the behavior profile includes driving violations by the operator within the travel area and the location is unfamiliar to the operator.

9. The prediction system of claim 1, wherein the feedback is generated by a voice assistant within the vehicle.

10. A non-transitory computer-readable medium comprising:
instructions that when executed by a processor cause the processor to:
generate a behavior profile of an operator from historical data and estimate a vehicle law, the historical data is acquired about a travel area associated with the operator and the behavior profile includes driving habits of the operator;
predict a violation parameter of the vehicle law from the behavior profile and a vehicle maneuver at a location, and the location is outside of the travel area; and
upon satisfaction of the violation parameter, output feedback by a vehicle about the vehicle law.

11. The non-transitory computer-readable medium of claim 10, wherein the instructions to satisfy the violation parameter further include instructions to detect that the vehicle maneuver violates the vehicle law, and the vehicle law applies outside of the travel area and the vehicle law is absent within the travel area.

12. A method comprising:
generating a behavior profile of an operator from historical data and estimating a vehicle law, the historical data is acquired from a travel area associated with the operator and the behavior profile includes driving habits about the operator;
predicting a violation parameter of the vehicle law from the behavior profile and a vehicle maneuver at a location, and the location is outside of the travel area; and
upon satisfying the violation parameter, outputting feedback by a vehicle about the vehicle law.

13. The method of claim 12, wherein satisfying the violation parameter further includes detecting that the vehicle maneuver violates the vehicle law, and the vehicle law applies outside of the travel area and the vehicle law is absent within the travel area.

14. The method of claim 13, wherein predicting the violation parameter further includes inferring enforcement of the vehicle law by factoring one of a safety zone, radar enforcement, and a speed camera associated with the location.

15. The method of claim 12, wherein predicting the violation parameter further includes inferring a confidence level of the operator for the vehicle maneuver and travel within the location using data from a sensor, and the data includes one of a steering angle, a braking frequency, a pulse rate, a respiratory rate, electrodermal activity, pupil dilation, and body temperature associated with the operator.

16. The method of claim 15, wherein predicting the violation parameter further includes computing a probability of a collision associated with the location.

17. The method of claim 12, wherein estimating the vehicle law further includes identifying traffic symbols using image data about a scene surrounding the vehicle.

18. The method of claim 12, wherein the behavior profile is portable to a transportation apparatus other than the vehicle.

19. The method of claim 12, wherein the behavior profile includes driving violations by the operator within the travel area and the location is unfamiliar to the operator.

20. The method of claim 12, wherein the feedback is generated by a voice assistant within the vehicle.
